(19) United States
(12) Patent Application Publication
(10) Pub. No.: US 2015/0102270 A1
(43) Pub. Date: Apr. 16, 2015

(54) THERMOSETTING CONDUCTIVE SILICONE COMPOSITION, CONDUCTIVE ADHESIVE COMPRISING THE SAME, CONDUCTIVE DIE BONDING MATERIAL COMPRISING THE SAME, AND PHOTOSEMICONDUCTOR APPARATUS HAVING CURED PRODUCT OF DIE BONDING MATERIAL

(71) Applicant: SHIN-ETSU CHEMICAL CO., LTD., Tokyo (JP)

(72) Inventors: Satoshi ONAI, Takasaki (JP); Toshiyuki OZAI, Takasaki (JP)

(21) Appl. No.: 14/468,728

(22) Filed: Aug. 26, 2014

(30) Foreign Application Priority Data
Oct. 15, 2013 (JP) 2013-214594

(51) Int. Cl. C09J 9/02

(52) U.S. Cl. CPC C09J 9/02; C09J 2483/00
USPC 252/514; 252/519.31; 252/500

(57) ABSTRACT

A thermosetting conductive silicone composition comprises an organopolysiloxane having at least one structure represented by the following formula (1),

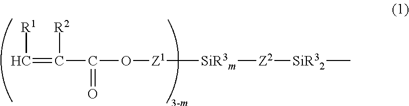

wherein m is either of 0, 1 or 2; R¹ represents a hydrogen atom, a phenyl group or a halogenated phenyl group; R² represents a hydrogen atom or methyl group; R³s may be the same or different from each other and each represents a substituted or unsubstituted monovalent organic group having 1 to 12 carbon atoms; Z¹ represents either of —R⁴—, —R⁴—O— or —R⁴(CH₃)₂Si—O— where R⁴s may be the same or different from each other and each represents a substituted or unsubstituted divalent organic group having 1 to 10 carbon atoms; and Z²s represent an oxygen atom or a substituted or unsubstituted divalent organic group having 1 to 10 carbon atoms which may be the same or different from each other; an organic peroxide; and conductive particles.

### TECHNICAL FIELD

The present invention relates to a thermosetting conductive silicone composition, a conductive adhesive comprising said composition, conductive die bonding material comprising said composition, and a photosemiconductor apparatus having a cured product of said die bonding material.

### BACKGROUND ART

A photosemiconductor device such as a light-emitting diode (LED), etc., has excellent characteristics that electric power consumption is a little, so that an application of the photosemiconductor device to outdoor lighting usage and automotive applications is increasing. Such a photosemiconductor device is a light-emitting device in which the light emitted from a photosemiconductor light-emitting device that generally emits blue light, near-ultraviolet light or ultraviolet light is converted its wavelength by a phosphor which is a wavelength converting material to obtain a pseudo white color.

In recent years, development of a vertical photosemiconductor device has been carried out for the purpose of further improvement in luminous efficiency of the photosemiconductor device. The vertical photosemiconductor device is a device in which an electrode is provided with a vertical structure, and is simply called as a vertical LED chip. The vertical LED chip can flow several ten-fold electric current as compared with the same size of a lateral LED chip in which an electrode is provided with a lateral structure by flowing an electric current through the luminous layer uniformly, whereby increase in the temperature of the luminous layer can be suppressed and luminous efficiency can be heightened. Further, it has excellent characteristics that increase in local current density observed in the lateral LED chip can be suppressed, and larger amount of electric current of the LED can be flowed, so that its practical application is in progress.

On the other hand, the vertical LED chip is required to electrically bonding one of the electrodes by using the method such as a wire bond, etc., similarly as in the conventional manner, and is required to electrically bonding the other electrode by using a eutectic solder or a conductive adhesive, etc., when the vertical LED chip is to be mounted on a wiring board, as can be understood that the electrode is provided at a vertical structure as mentioned above.

As an adhesive for mounting the vertical LED chip on the wiring board, a eutectic solder or a conductive adhesive in which conductive particles are formulated into an epoxy resin composition has heretofore been widely used. In the method of using the eutectic solder, it is not preferred since heat necessary to melt the solder at the time of die bonding causes damage to the luminous layer of the photosemiconductor.

On the other hand, as an example of using the conductive adhesive, for example, in Patent Literature 1, a conductive adhesive in which a bisphenol A type epoxy resin or a bisphenol F type epoxy resin and an alicyclic epoxy resin are used in combination, and a benzotriazole derivative is added as an UV-absorber to improve light resistance to the light at about 450 to 500 nm has been proposed. However, as mentioned above, the photosemiconductor device becomes a vertical and due to higher output, and light resistance to blue light or ultraviolet rays having a shorter wavelength is not sufficient in the epoxy resin conductive composition, and the problem is still generating that discoloration or decomposition occurs due to deterioration by light with a lapse of time.

In Patent Literature 2, it has been proposed a die bonding material for a photosemiconductor device comprising a specific conductive powder, an organopolysiloxane having a (3,5-diglycidylisocyanuryl)alkyl group and a curing catalyst (amine series catalyst, phenol series catalyst, acid anhydride series catalyst) which reacts with a glycidyl group. However, the organic group represented by an isocyanuryl group is similarly deteriorated by light of shorter wavelength, and the problems are generated that it is colored and decomposed with a lapse of time.

### CITATION LIST

### Patent Literature

PATENT LITERATURE 1: JP Patent No. 3769152

PATENT LITERATURE 2: JP 2012-52029A

### SUMMARY OF THE INVENTION

### Technical Problem

The present invention has been accomplished in view of the above-mentioned problems, and an object thereof is to provide a thermosetting conductive silicone composition excellent in adhesive strength and workability, and providing a cured product having heat resistance, light resistance and crack resistance. It is also an object of the same to provide a conductive adhesive comprising said composition, and a conductive die bonding material comprising said composition. Moreover, it is a further object of the same to provide a photosemiconductor apparatus in which a photosemiconductor device is die bonded by said die bonding material.

### Solution to Problem

To solve the above-mentioned problems, in the present invention, it is provided a thermosetting conductive silicone composition which comprises (A) an organopolysiloxane having at least one structure represented by the following general formula (1) in the molecule: 100 parts by mass,

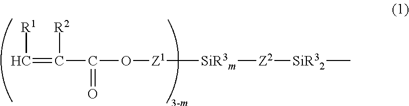

wherein “m” represents either of 0, 1 or 2; R¹ represents a hydrogen atom, a phenyl group or a halogenated phenyl group; R² represents a hydrogen atom or a methyl group; R³s may be the same or different from each other and each represents a substituted or unsubstituted monovalent organic group having 1 to 12 carbon atoms, Z¹ represents either of —R⁴—, —R⁴—O— or —R⁴(CH₃)₂Si—O— where R⁴s may be the same or different from each other and each represents a substituted or unsubstituted divalent organic group having 1 to 10 carbon atoms; Z²s represent an oxygen atom or a substituted or unsubstituted divalent organic group having 1 to 10 carbon atoms which may be the same or different from each other,

(B) an organic peroxide: 0.1 to 10 parts by mass based on the total amount of Component (A) as 100 parts by mass; and
(C) conductive particles: 0.1 to 1,000 parts by mass based on the solid contents of Component (A) and Component (B) as 100 parts by mass.

When such a thermosetting conductive silicone composition is employed, it is excellent in adhesive strength and workability, and a cured product excellent in heat resistance, light resistance and crack resistance can be provided.

It is also preferred that Z¹ in the above-mentioned organopolysiloxane of Component (A) is —R⁴—, and the above-mentioned Z² is an oxygen atom.

It is further preferred that Z¹ in the above-mentioned organopolysiloxane of Component (A) is —R⁴—O— or —R⁴(CH₃)₂Si—O—, and the above-mentioned Z² is a substituted or unsubstituted divalent organic group having 1 to 10 carbon atoms which may be the same or different from each other.

When Z¹ and Z² are in such a combination, the effects of the thermosetting conductive silicone composition of the present invention are more improved.

Also, it is preferred that 0.1 mole % or more of a (SiO₂) unit is contained in the above-mentioned organopolysiloxane of Component (A).

When such a thermosetting conductive silicone composition is employed, it effectively reacts with a free radical(s) generating from Component (B) when it decomposes, whereby the composition is excellent in adhesive strength and workability, and provides a cured product excellent in heat resistance, light resistance and crack resistance.

Further, it is preferred that the above-mentioned organopolysiloxane of Component (A) has at least one structure represented by the following general formula (2) in the molecule,

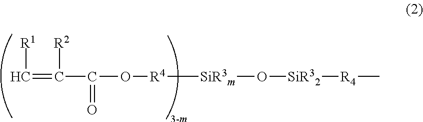

wherein “m”, R¹, R², R³, R⁴ have the same meanings as defined above.

It is particularly suitable that the thermosetting conductive silicone composition of the present invention has such a unit.

Moreover, in the present invention, it is provided a conductive adhesive comprising the above-mentioned thermosetting conductive silicone composition of the present invention.

When such a conductive adhesive is employed, it is appropriately used as an adhesive for mounting an LED chip on a wiring board.

Furthermore, in the present invention, it is provided a conductive die bonding material comprising the above-mentioned thermosetting conductive silicone composition of the present invention, which is used to conductively connect a semiconductor device to a wiring board.

When such a conductive die bonding material is employed, it can be appropriately used as an adhesive for mounting an LED chip on a wiring board.

Further, in the present invention, it is provided a photosemiconductor apparatus comprising a cured product obtained by curing the above-mentioned conductive die bonding material of the present invention.

The composition of the present invention is excellent in adhesive strength and workability, and can provide a cured product excellent in heat resistance, light resistance and crack resistance. Therefore, the photosemiconductor apparatus comprising a cured product obtained by curing the conductive die bonding material which comprises the composition of the present invention becomes a material having heat resistance, light resistance and crack resistance.

### Advantageous Effects of Invention

The thermosetting conductive silicone composition of the present invention is excellent in adhesive strength and workability, and can provide a cured product (transparent cured product) having heat resistance, light resistance, crack resistance and discoloration resistance, so that it can be appropriately used as an adhesive for mounting an LED chip, in particular, a vertical LED chip on a wiring board.

### BRIEF DESCRIPTION OF DRAWINGS

FIG. 1 is a sectional view showing an example of a photosemiconductor apparatus comprising a cured product obtained by curing the conductive die bonding material which comprises the composition of the present invention.

### DESCRIPTION OF EMBODIMENTS

In the following, the present invention is explained in more detail.

As mentioned above, a thermosetting conductive silicone composition excellent in adhesive strength and workability, and provide a cured product having heat resistance, light resistance and crack resistance has been required.

The present inventors have intensively studied to accomplish the above-mentioned objects, and as a result, they have found out that a thermosetting conductive silicone composition comprising

(A) an organopolysiloxane having at least one structure represented by the following general formula (1) in the molecule: 100 parts by mass,

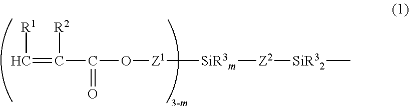

wherein “m” represents either of 0, 1 or 2; R¹ represents a hydrogen atom, a phenyl group or a halogenated phenyl group; R² represents a hydrogen atom or a methyl group; R³s may be the same or different from each other and each represents a substituted or unsubstituted monovalent organic group having 1 to 12 carbon atoms; Z¹ represents either of —R⁴—, —R⁴—O— or —R⁴(CH₃)₂Si—O— where R⁴s may be the same or different from each other and each represents a substituted or unsubstituted divalent organic group having 1 to 10 carbon atoms; and Z²s represent an oxygen atom or a substituted or unsubstituted divalent organic group having 1 to 10 carbon atoms which may be the same or different from each other;

(B) an organic peroxide: 0.1 to 10 parts by mass based on the total amount of Component (A) as 100 parts by mass;
(C) conductive particles: 0.1 to 1,000 parts by mass based on the solid contents of Component (A) and Component (B) as 100 parts by mass,
is excellent in adhesive strength and workability, and can provide a cured product excellent in heat resistance, light resistance and crack resistance and can provide a photosemiconductor apparatus having high reliability, whereby the present invention has been accomplished.

In the following, the present invention is explained more specifically, but the present invention is not limited by these.

### [(A) Organopolysiloxane]

The organopolysiloxane of Component (A) is an organopolysiloxane having at least one structure represented by the following general formula (1) in the molecule,

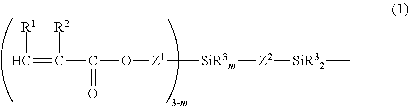

wherein “m” represents either of 0, 1 or 2; R¹ represents a hydrogen atom, a phenyl group or a halogenated phenyl group; R² represents a hydrogen atom or a methyl group; R³s may be the same or different from each other and each represents a substituted or unsubstituted monovalent organic group having 1 to 12 carbon atoms; Z¹ represents either of —R⁴—, —R⁴—O— or —R⁴(CH₃)₂Si—O— where R⁴s may be the same or different from each other and each represents a substituted or unsubstituted divalent organic group having 1 to 10 carbon atoms; and Z²s represent an oxygen atom or a substituted or unsubstituted divalent organic group having 1 to 10 carbon atoms which may be the same or different from each other.

As the combination of Z¹ and Z² in the organopolysiloxane of Component (A), a material in which Z¹ is —R⁴— and Z² is an oxygen atom, or a material in which Z¹ is —R⁴—O— or —R⁴(CH₃)₂Si—O—, and Z² represents a substituted or unsubstituted divalent organic group having 1 to 10 carbon atoms which may be the same or different from each other is preferred since it effectively reacts with the free radical which is generated from Component (B) when it is decomposed, the composition is excellent in adhesive strength and workability, and a cured product excellent in heat resistance, light resistance and crack resistance can be obtained.

It is also preferred that 0.1 mole % or more of a (SiO₂) unit is contained in the organopolysiloxane of Component (A) since it effectively reacts with the free radical which is generated from Component (B) when it is decomposed, the composition is excellent in adhesive strength and workability, and a cured product excellent in heat resistance, light resistance and crack resistance can be obtained.

It is further preferred that the organopolysiloxane of Component (A) has at least one structure represented by the following general formula (2) in the molecule, since it effectively reacts with the free radical which is generated from Component (B) when it is decomposed, the composition is excellent in adhesive strength and workability, and a cured product excellent in heat resistance, light resistance and crack resistance can be obtained,

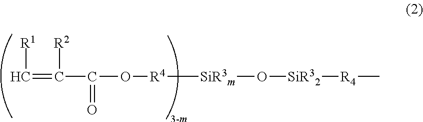

wherein “m”, R¹, R², R³, R⁴ have the same meanings as defined above.

The organopolysiloxane of Component (A) is preferably an organopolysiloxane which is a liquid state having a viscosity at 25° C. of 10 mPa·s or more or a solid and has a branched or a three-dimensional network structure.

In the above-mentioned formula (1), the substituted or unsubstituted monovalent organic group bonded to the silicon atom which may be the same or different from each other and represented by R³ may be generally mentioned a hydrocarbon group having 1 to 12 carbon atoms, preferably 1 to 8 carbon atoms or so, and specifically mentioned an alkyl group such as a methyl group, an ethyl group, a propyl group, an isopropyl group, a butyl group, an isobutyl group, a tert-butyl group, a pentyl group, a neopentyl group, a hexyl group, a cyclohexyl group, an octyl group, a nonyl group, a decyl group, etc.; an aryl group such as a phenyl group, a tolyl group, a xylyl group, a naphthyl group, etc.; an aralkyl group such as a benzyl group, a phenylethyl group, a phenylpropyl group, etc.; an alkenyl group such as a vinyl group, an allyl group, a propenyl group, an isopropenyl group, a butenyl group, a hexenyl group, a cyclohexenyl group, an octenyl group, etc.; or a part or whole of the hydrogen atom(s) of these groups is/are substituted by a halogen atom(s) such as fluorine, bromine, chlorine, etc., or a cyano group, etc., for example, a halogen-substituted alkyl group such as a chloromethyl group, a chloropropyl group, a bromoethyl group, a trifluoropropyl group, etc., or a cyanoethyl group, etc.

In the above-mentioned formula (1), the substituted or unsubstituted divalent organic group which may be the same or different from each other and represented by R⁴ may be specifically exemplified by a divalent hydrocarbon group such as an alkylene group having 1 to 10 carbon atoms including a methylene group, an ethylene group, a propylene group, a butylene group, etc., and an alkylene group having 1 to 3 carbon atoms is preferred.

In the following, the organopolysiloxane of Component (A) is exemplified. (In the following formulae, Me represents a methyl group.) This component may be a single component or in admixture with the other component(s). Also, in the following formula, the case where the group corresponding to R³ of the above-mentioned formula (1) is a methyl group is exemplified, and it may be changed to the other group (a substituted or unsubstituted and may be the same or different monovalent organic group having 1 to 12 carbon atoms).

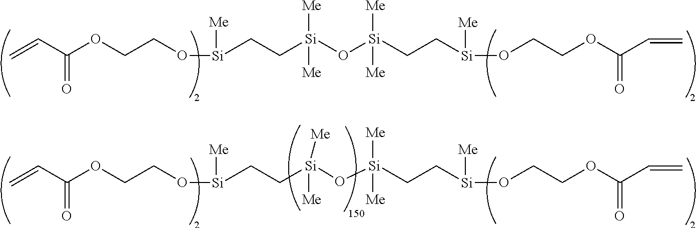

An organopolysiloxane which contains an MA unit, an M unit and a Q unit shown by the following formulae with a ratio of MA:M:Q=1:4:6, and has a molecular weight of 5,000 which is a weight average molecular weight in terms of a polystyrene.

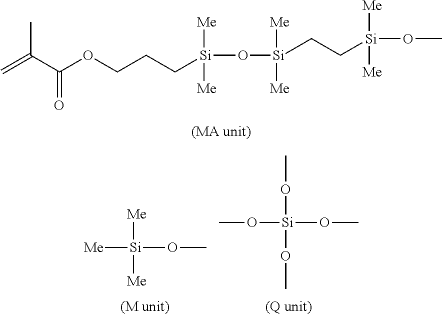

An organopolysiloxane which contains an MA-D unit, a D unit and a T unit shown by the following formulae with a ratio of MA-D:D:T=2:6:7, and has a molecular weight of 3,500 which is a weight average molecular weight in terms of a polystyrene.

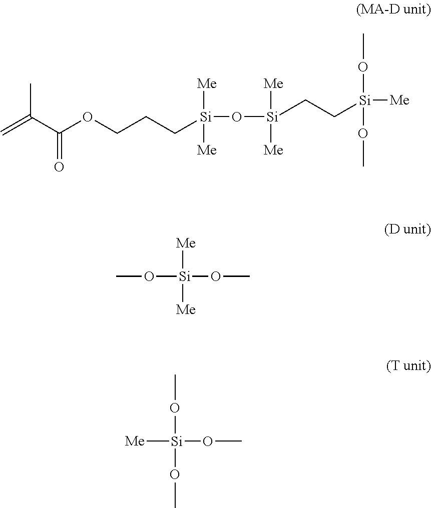

To Component (A), a reactive diluent containing a silicone as shown below, or a reactive diluent containing no silicone may be added for the purposes of adjusting viscosity of the composition or hardness of the cured product, etc.

Specific examples of the reactive diluent containing a silicone may be mentioned organopolysiloxanes represented by the following formulae (3) to (7). (In the following formula, Me represents a methyl group.) This component may be a single component or in admixture with the other component(s).

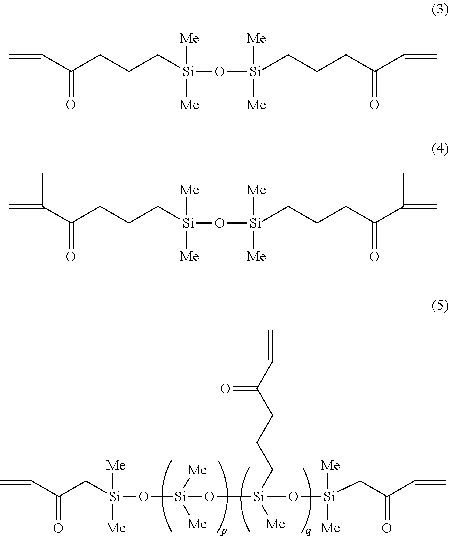

wherein “p” represents 18 and “q” represents 180.

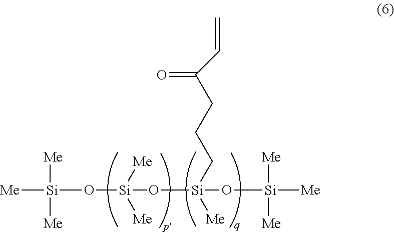

wherein “p′” represents 20 and “q” represents 180.

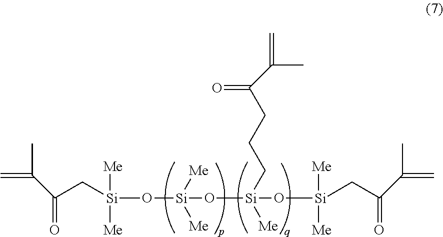

wherein “p” represents 18 and “q” represents 180.

As a synthesizing method of such Component (A), there may be mentioned, for example, a method in which an organosilane represented by the following general formula or an organohydrogen polysiloxane,

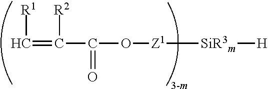

wherein “m”, R¹, R², R³ and Z¹ have the same meanings as defined above,

and an organopolysiloxane having an aliphatic unsaturated group (for example, there may be mentioned an ethylenic unsaturated group and an acetylenic unsaturated group.) are subjected to hydrosilylation in the presence of a chloroplatinic acid catalyst, and a suitable product in the present invention can be manufactured by the method, but the synthesizing method of such Component (A) is not limited to the above-mentioned synthetic method. A commercially available product may be also used.

A reactive diluent containing no silicone may be mentioned a (meth)acrylate represented by H₂C═CGCO₂R⁵, wherein G represents either of hydrogen, a halogen or an alkyl group having 1 to 4 carbon atoms; R⁵ is selected from either of an alkyl group having 1 to 16 carbon atoms, a cycloalkyl group, an alkenyl group, a cycloalkenyl group, an alkaryl group, a aralkyl group or an aryl group, and any of these may be substituted by silicon, oxygen, a halogen, carbonyl, hydroxyl, an ester, a carboxylic acid, urea, a urethane, a carbamate, an amine, an amide, sulfur, a sulfonate, a sulfone, etc., if necessary.

Particularly desirable (meth)acrylate as a reactive diluent may be mentioned an acrylate ester corresponding to polyethylene glycol di(meth)acrylate, bisphenol A di(meth)acrylate such as an ethoxylated bisphenol A (meth)acrylate (“EBIPA” or “EBIPMA”), tetrahydrofuran (meth)acrylate and di(meth)acrylate, citronellyl acrylate and citronellyl methacrylate, hydroxylpropyl (meth)acrylate, hexanediol di(meth)acrylate (“HDDA” or “HDDMA”), trimethylolpropane tri(meth)acrylate, tetrahydrodicyclopentadienyl (meth)acrylate, ethoxylated trimethylolpropane triacrylate (“ETTA”), triethylene glycol diacrylate and triethylene glycol dimethacrylate (“TRIEGMA”), isobornyl acrylate and isobornyl methacrylate. Of course, an optional combination of these (meth)acrylates may be used as a reactive diluent.

A formulation amount of the reactive diluent when it is added is preferably in the range of 0.01 to 30% by mass, more preferably in the range of 0.05 to 10% by mass.

The composition of the present invention may contain other component(s) which can modify cured or uncured characteristics desired in a specific use. It may contain, for example, an adhesion promoter such as (meth)acryloxypropyltrimethoxysilane, trialkyl- or triallyl-isocyanurate, glycidoxypropyltrimethoxysilane, vinyltrimethoxysilane, etc., an amount of which is preferably contained up to about 20% by mass. Other optional component(s) may be mentioned a non-(meth)acryl silicone diluent or a plasticizer, an amount of which is preferably contained up to about 30% by mass. The non-(meth)acryl silicones may be mentioned trimethylsilyl-terminated oil having a viscosity of 100 to 500 mPa·s, and silicone rubber. The non(meth)acryl silicones may contain a co-curable group such as a vinyl group.

### [(B) Organic Peroxide]

The organic peroxide of Component (B) is a component formulating for curing the composition by cross-linking reaction under heat treatment after the present composition has been molded to a desired shape, and optionally selected depending on an objective connection temperature, connection time, pot life, etc.

The organic peroxide preferably has a temperature where a half-life period of 10 hours being 40° C. or higher, and a temperature where a half-life period of 1 minute being 180° C. or lower in the viewpoint of coexisting high reactivity and long pot life, more preferably a temperature where a half-life period of 10 hours being 60° C. or higher, and, a temperature where a half-life period of 1 minute being 170° C. or lower. Also, the organic peroxide is preferably a material in which a content of a chlorine ion or an organic acid is 5,000 ppm or less to prevent corrosion of a circuit electrode (connecting terminal) of a circuit member, and further, more preferably a material in which an amount of an organic acid generated after decomposition by heating is a little.

In this case, according to free radicals generated by thermal decomposition of the organic peroxide, bonding reaction of the hydrocarbon groups to each other bonded to the silicon atom in the above-mentioned Component (A), or alkenyl groups such as a vinyl group, an allyl group, etc., to each other in the above-mentioned Component (A) to prepare a cross-linked cured product.

The organic peroxide may be used any of the conventionally known materials to be used in the radical polymerization reaction, etc., more specifically one or more selected from the group consisting of a diacyl peroxide, a dialkyl peroxide, a peroxy dicarbonate, a peroxy ester, a peroxy ketal, a hydroperoxide and a silyl peroxide is/are appropriately used. Among these, one or more selected from the group consisting of a peroxy ester, a dialkyl peroxide and a hydroperoxide is/are preferred to further suppress corrosion of a connecting structure of a circuit member or a connecting terminal in the semiconductor apparatus.

The diacyl peroxide may be mentioned, for example, isobutyl peroxide, 2,4-dichlorobenzoyl peroxide, 3,5,5-trimethylhexanoyl peroxide, octanoyl peroxide, lauroyl peroxide, stearoyl peroxide, succinic peroxide, benzoyl peroxytoluene and benzoyl peroxide. These may be used a single kind alone or two or more kinds in combination.

The dialkyl peroxide may be mentioned, for example, α,α′-bis(t-butylperoxy)diisopropylbenzene, dicumyl peroxide, 2,5-dimethyl-2,5-bis(t-butylperoxy)hexane and t-butylcumyl peroxide. These may be used a single kind alone or two or more kinds in combination.

The peroxy dicarbonate may be mentioned, for example, di-n-propylperoxy dicarbonate, diisopropylperoxy dicarbonate, bis(4-t-butylcyclohexyl)peroxy dicarbonate, di-2-ethoxymethoxyperoxy dicarbonate, bis(2-ethylhexylperoxy)dicarbonate, dimethoxybutylperoxy dicarbonate and bis(3-methyl-3-methoxybutylperoxy)dicarbonate. These may be used a single kind alone or two or more kinds in combination.

The peroxy ester may be mentioned, for example, cumyl peroxy neodecanoate, 1,1,3,3-tetramethylbutylperoxy neodecanoate, 1-cyclohexyl-1-methylethylperoxy neodecanoate, t-hexylperoxy neodecanoate, t-butylperoxypivalate, 1,1,3,3-tetramethylbutylperoxy-2-ethylhexanoate, 2,5-dimethyl-2,5-bis(2-ethylhexanoylperoxy)hexane, 1-cyclohexyl-1-methylethylperoxy-2-ethylhexanoate, t-hexylperoxy-2-ethylhexanonate, t-butylperoxy-2-ethylhexanoate, t-butylperoxy isobutyrate, 1,1-bis(t-butylperoxy)cyclohexane, t-hexylperoxy isopropylmonocarbonate, t-butylperoxy-3,5,5-trimethylhexanonate, t-butylperoxy laurate, 2,5-dimethyl-2,5-bis(m-toluoylperoxy)hexane, t-butylperoxy isopropylmonocarbonate, t-butylperoxy-2-ethylhexylmonocarbonate, t-hexylperoxy benzoate, t-butylperoxy acetate and bis(t-butylperoxy)hexahydroterephthalate. These may be used a single kind alone or two or more kinds in combination.

The peroxy ketal may be mentioned, for example, 1,1-bis(t-hexylperoxy)-3,3,5-trimethylcyclohexane, 1,1-bis(t-hexylperoxy)cyclohexane, 1,1-bis(t-butylperoxy)-3,3,5-trimethylcyclohexane, 1,1-(t-butylperoxy)cyclododecane and 2,2-bis(t-butylperoxy)decane. These may be used a single kind alone or two or more kinds in combination.

The hydroperoxide may be mentioned, for example, diisopropyl benzene hydroperoxide and cumene hydroperoxide. These may be used a single kind alone or two or more kinds in combination.

The silyl peroxide may be mentioned, for example, t-butyltrimethylsilyl peroxide, bis(t-butyl)dimethylsilyl peroxide, t-butyltrivinylsilyl peroxide, bis(t-butyl)divinylsilyl peroxide, tris(t-butyl)vinylsilyl peroxide, t-butyltriallylsilyl peroxide, bis(t-butyl)diallylsilyl peroxide and tris(t-butyl)allylsilyl peroxide. These may be used a single kind alone or two or more kinds in combination.

An amount of Component (B) to be added is 0.1 to 10 parts by mass based on the total amount of the organopolysiloxane of Component (A) of 100 parts by mass, preferably 0.5 to 5 parts by mass. If the amount to be added is less than 0.1 part by mass, there is a fear of not proceeding the reaction sufficiently. If it exceeds 10 parts by mass, there is a fear that desired physical properties after curing, i.e., sufficient heat resistance, light resistance, crack resistance cannot be obtained.

### [(C) Conductive Particles]

The conductive particles of the present invention may be used metal particles, metal coated resin particles, conductive inorganic oxides, which may be used singly or in admixture of two or more kinds. A size of the particles is not particularly limited, and is preferably 0.2 to 20 μm, more preferably 0.3 to 10 μm. A preferred shape of the particles may be mentioned spherical, flake, needle, amorphous, etc., but the invention is not limited by these.

The metal particles may be mentioned, for example, gold, nickel, copper, silver, solder, palladium, aluminum, an alloy thereof, a multi-layered product thereof (for example, nickel plated/gold flash plated product), etc. Among these, silver, solder, palladium or aluminum is preferred which is never made the conductive particles brown color. A preferred size and shape of these metal particles may be mentioned 0.2 to 10 μm size spherical particles, or flake shaped particles with a thickness of 0.2 to 0.4 μm and a diameter of 1 to 10 μm.

Also, as the conductive particles, metal coated resin particles in which resin particles have been coated by a metal material may be used. The resin particles constituting such metal coated resin particles may be mentioned styrene series resin particles, benzoguanamine resin particles, Nylon® resin particles, etc. A method of coating the resin particles by a metal material may be employed the conventionally known methods, and the electroless plating method, the electrolytic plating method, etc., may be utilized. Further, a layer thickness of the metal material to be coated is a thickness sufficient for ensuring good connection reliability, which may vary depending on a particle diameter of the resin particles and a kind of the metal, and is generally 0.1 to 10 μm.

Moreover, the particle diameter of the metal coated resin particles is preferably 1 to 20 μm, more preferably 3 to 10 μm, particularly preferably 3 to 5 μm. If the particle diameter is in the range of 1 to 20 μm, conduction failure or a short circuit between the patterns is never generated. In this case, a shape of the metal coated resin particles is preferably spherical, and may be needle or flake.

In addition, as the conductive inorganic oxides, a material in which conductivity is provided to the inorganic oxides may be used. As the inorganic particles constituting such metal coated inorganic particles may be mentioned titanium oxide (TiO₂), boron nitride (BN), zinc oxide (ZnO), silicon oxide (SiO₂), aluminum oxide (Al₂O₃), inorganic glass, etc. Among these, titanium oxide, silicon oxide and aluminum oxide are preferred. The coating layer of the conductive inorganic oxides may be any material so long as conductivity is provided thereto, and it may be a material in which an inorganic oxide is coated by a metal material such as silver, etc., or a conductive coating layer may be provided by doping antimony to tin oxide or doping tin to indium oxide, etc.

These conductive inorganic particles are inorganic particles having white color under sunlight, which likely reflect visible light. A particle diameter of the inorganic particles is preferably 0.02 to 10 μm, more preferably 0.1 to 3 μm. A shape of the inorganic particles may be mentioned amorphous, spherical, scaly, needle, etc.

A formulation amount of the conductive particles is 0.1 to 1,000 parts by mass, preferably 1 to 500 parts by mass based on the solid content of Component (A) and Component (B) in the adhesive composition as 100 parts by mass. It is necessary to formula 0.1 part by mass to provide conductivity, while if it exceeds 1,000 parts by mass, there is a fear that fluidity of the resin composition is impaired and workability is lowered. Also, there is a fear that it causes lowering in strength of the resin cured product.

A particle diameter of the conductive particles of Component (C) according to the present invention is a value measured as a cumulative volume average value D₅₀ (or median diameter) in a particle size distribution measurement using laser light diffraction.

### [(D) Other Component(s)]

A conventionally known antioxidant such as 2,6-di-t-butyl-4-methylphenol, etc., may be formulated into the composition of the present invention for the purpose of further maintaining transparency of the composition and suppressing occurrence of coloration, oxidation deterioration, etc., of the cured product. Also, a photostabilizer such as a hindered amine type stabilizer, etc., may be formulated into the composition of the present invention for the purpose of providing resistance to photodegradation.

An inorganic filler such as fumed silica, nanoalumina, etc., may be further formulated into the composition of the present invention to improve strength thereof and suppress sedimentation of the particles. If necessary, a dye, a pigment, a flame retardant, etc., may be formulated into the composition of the present invention.

It is also possible to use the composition by adding a solvent, etc., for the purpose of improving workability. A kind of the solvent is not particularly limited, and it may be any solvent so long as it can dissolve the resin composition before curing, can disperse the conductive powder well, or can provide a uniform die bonding material or adhesive, etc. A formulation ratio of the solvent may be optionally adjusted depending on working conditions, an environment, a used time, etc., to use the die bonding material, etc. The solvent may be used two or more kinds in combination. Such a solvent may be mentioned butyl Carbitol® acetate, Carbitol® acetate, methyl ethyl ketone, α-terpineol, and Cellosolve® acetate, etc.

In addition, the composition of the present invention may contain a tackifier for improving adhesiveness. The tackifier may be exemplified by a silane coupling agent or its hydrolysis condensate, etc. The silane coupling agent may be exemplified by the conventionally known materials such as an epoxy group-containing silane coupling agent, a (meth)acryl group-containing silane coupling agent, an isocyanate group-containing silane coupling agent, an isocyanurate group-containing silane coupling agent, an amino group-containing silane coupling agent, a mercapto group-containing silane coupling agent, etc., and can be used in an amount of preferably 0.1 to 20 parts by mass, more preferably 0.3 to 10 parts by mass based on the total amount of Component (A) and Component (B) as 100 parts by mass.

The resin composition of the present invention can be manufactured by mixing the above-mentioned respective components using the conventionally known mixing method, for example, a mixer, a roller, etc. Also, the resin composition of the present invention preferably has a viscosity of 10 to 1,000,000 mPa·s, particularly preferably 100 to 1,000,000 mPa·s as a measured value using a rotational viscometer, or an E type viscometer at 23° C.

The composition of the present invention can be cured by the conventionally known curing method under the conventionally known curing conditions. More specifically, the composition can be cured by heating generally at 80 to 200° C., preferably at 100 to 160° C. A heating time may be 0.5 minute to 5 hours or so, particularly 1 minute to 3 hours or so. The conditions can be optionally selected depending on the balance with the working conditions, productivity, light emitting device and heat resistance of a cabinet.

The conductive resin composition of the present invention can be appropriately used for fixing the vertical LED chip to the package. Also, it can be appropriately used for other photosemiconductor devices such as a light-emitting diode (LED), organic electroluminescent device (organic EL), a laser diode, and an LED array, etc.

Further, in the present invention, it is provided a conductive adhesive comprising the above-mentioned thermosetting conductive silicone composition of the present invention. Moreover, it is further provided a conductive die bonding material comprising the above-mentioned thermosetting conductive silicone composition of the present invention, which is used to conductively connect the semiconductor device to a wiring board.

When such a conductive adhesive and a conductive die bonding material are employed, they can be appropriately used as an adhesive for mounting an LED chip on a wiring board.

A method for coating the die bonding material is not particularly limited, and may be mentioned, for example, spin coating, printing and compression molding, etc. A thickness of the die bonding material may be optionally selected, and generally 5 to 50 μm, particularly 10 to 30 μm. It can be easily coated, for example, by discharging the material using a dispensing apparatus at a temperature of 23° C. and a pressure of 0.5 to 5 kgf/cm². Also, by using a stamping apparatus, a predetermined amount of the die bonding material can be easily transferred to the substrate.

Further, in the present invention, it is provided a photosemiconductor apparatus comprising a cured product obtained by curing the above-mentioned conductive die bonding material of the present invention.

The photosemiconductor apparatus of the present invention comprises a cured product obtained by curing the conductive die bonding material comprising the composition of the present invention, so that it becomes a material having heat resistance, light resistance and crack resistance.

The photosemiconductor apparatus of the present invention can be manufactured by coating the die bonding material comprising the composition of the present invention on a substrate, and then, die bonding the photosemiconductor device according to the conventionally known method.

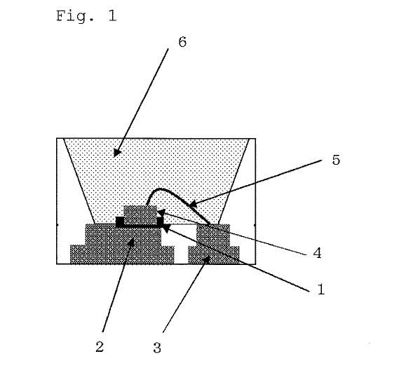

In the following, an embodiment of the photosemiconductor apparatus according to the present invention is explained by referring to the drawing. FIG. 1 is a sectional view showing one example of the photosemiconductor apparatus comprising the cured product obtained by curing the conductive die bonding material which comprises the composition of the present invention. The photosemiconductor apparatus has a constitution that a bottom electrode of a photosemiconductor device 4 and a first lead 2 are electrically connected by a conductive die bonding material 1, an upper electrode of the photosemiconductor device 4 and a second lead 3 are electrically connected by a wire 5, and the photosemiconductor device 4 is sealed by a sealing material 6.

As a manufacturing method of the photosemiconductor apparatus of FIG. 1, the following method may be exemplified.

A conductive die bonding material 1 is transferred with a predetermined amount to a first lead 2 on a package substrate, and a photosemiconductor device 4 is mounted thereon. Next, the conductive die bonding material 1 is cured by heating, a bottom electrode of the photosemiconductor device 4 and a first lead 2 are electrically connected. Then, the package substrate on which the photosemiconductor device 4 has been mounted is electrically connected to an upper electrode of the photosemiconductor device 4 and a second lead 3 using a wire 5, to obtain a package substrate on which the photosemiconductor device 4 has been mounted. Subsequently, a sealing material 6 is coated with a predetermined amount, and the sealing material 6 is cured by heating.

### EXAMPLES

In the following, the present invention is explained more specifically by referring to Examples and Comparative Examples, but the present invention is not limited by the following Examples. (in the following formula, Me represents a methyl group.)

### Preparation Example

### Preparation Examples 1 to 3

The following mentioned components were prepared and silicone compositions having the composition shown in Table 1 was prepared.

### [Component (A)]

### (A-1)

An organopolysiloxane containing an MA unit, an M unit and a Q unit shown by the following formulae with a ratio of MA:M:Q=1:4:6, and having a molecular weight with a weight average molecular weight in terms of a polystyrene of 5,000.

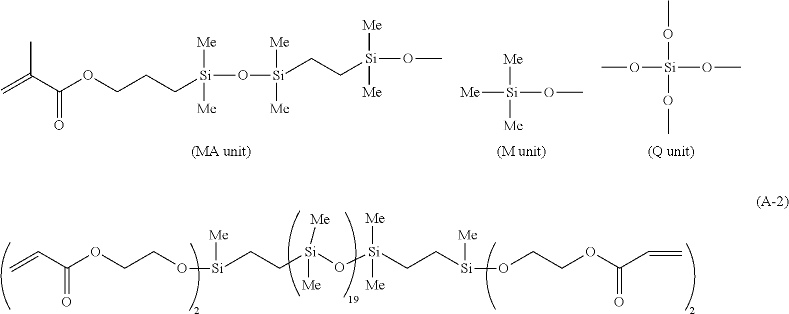

### (A-3)

An organopolysiloxane containing an MA-D unit, a D unit and a T unit shown by the following formulae with a ratio of MA-D:D:T=2:6:7, and having a molecular weight with a weight average molecular weight in terms of a polystyrene of 3,500. (in the following formula, Me represents a methyl group.)

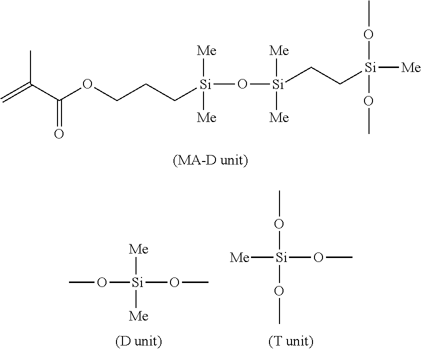

### [Component (B)]

(B) 1,1-Di(t-butylperoxy)cyclohexane (Trade name: perhexa C, available from NOF Corporation)

Formulation amounts of Component (A) and Component (B) used in Preparation Examples 1 to 3 are shown in Table 1.

TABLE 1

| | Preparation | Preparation | Preparation |
|---|---|---|---|
| | Example-1 | Example-2 | Example-3 |
| (A-1) | 80 | 70 | |
| (A-2) | 20 | 30 | 40 |
| (A-3) | | | 60 |
| (B) | 2 | 2 | 2 |

### Preparation Example-4

To 100 parts by mass of an organopolysiloxane resin copolymer (silicone resin) comprising a (C₆H₅)SiO_{3/2} unit, a (CH₂═CH) (CH₃) SiO_{2/2} unit and a (CH₃)₂SiO_{2/2} unit, and an average composition of which is shown by (CH₃)_{0.65} (C₆H₅)_{0.55}(CH₂═CH)_{0.25}SiO_{1.28} were mixed 20 parts by mass of phenyl methyl hydrogen siloxane having 20 mole % of a phenyl group based on the total of a methyl group, a phenyl group and a hydrogen atom (SiH group) bonded to the silicon atom, a hydrogen gas generating amount of which is 150 ml/g, and a viscosity of 10 mPa·s, and 0.2 part by mass of ethynylcyclohexanol, and to the mixture was mixed a platinum catalyst containing 20 ppm of a platinum atom, and defoamed under reduced pressure to prepare a silicone composition.

### Preparation Example-5

To 80 parts by mass of a cresol novolac type epoxy resin (Trade name: EOCN103S, available from DIC Corporation) and 20 parts by mass of a bisphenol A type epoxy resin (Trade name: Epikote #1007, available from Yuka Shell Epoxy K.K.) was added 40 parts by mass of a phenol resin (Trade name: BRG558, available from Showa Highpolymer Co., Ltd.) as a curing agent, and the mixture was dissolved in 140 parts by mass of diethylene glycol diethyl ether and reacted therein at 85° C. for 1 hour to obtain a viscous resin. With 28 parts by mass of the resin was mixed 0.2 part by mass of 2-ethyl-4-methylimidazole which is an imidazole as a curing catalyst, and the mixture was defoamed under reduced pressure to prepare an epoxy composition.

### Examples 1 to 8

### Example 1

100 parts by mass of the silicone composition obtained in Preparation Example 1, and 30 parts by mass of silver powder having an average particle diameter of 6.9 μm (Product name: SILVEST TCG-7, available from Tokuriki Chemical Research Co., Ltd.) as the conductive particles were mixed, further subjected to kneading treatment using a three roll mill, and defoamed under reduced pressure to manufacture a conductive paste (conductive resin composition) (a).

### Example 2

100 parts by mass of the silicone composition obtained in Preparation Example 2, and 30 parts by mass of silver powder having an average particle diameter of 6.9 μm (Product name: SILVEST TCG-7, available from Tokuriki Chemical Research Co., Ltd.) as the conductive particles were mixed, further subjected to kneading treatment using a three roll mill, and defoamed under reduced pressure to manufacture a conductive paste (b).

### Example 3

100 parts by mass of the silicone composition obtained in Preparation Example 3, 30 parts by mass of silver powder having an average particle diameter of 6.9 μm (Product name: SILVEST TCG-7, available from Tokuriki Chemical Research Co., Ltd.) as the conductive particles and 5 parts by mass of fumed silica (Product name: REOLOSIL DM-30S, available from K.K. Tokuyama) as a reinforcing material were mixed, further subjected to kneading treatment using a three roll mill, and defoamed under reduced pressure to manufacture a conductive paste (c).

### Example 4

100 parts by mass of the silicone composition obtained in Preparation Example 1, and 50 parts by mass of conductive titanium oxide having an average particle diameter of 0.3 μm (Product name: EC-210, available from Titan Kogyo, Ltd.) as the conductive particles were mixed, further subjected to kneading treatment using a three roll mill, and defoamed under reduced pressure to manufacture a conductive paste (d).

### Example 5

100 parts by mass of the silicone composition obtained in Preparation Example 1, 100 parts by mass of conductive silicon oxide having an average particle diameter of 0.3 μm (Product name: ES-650E, available from Titan Kogyo, Ltd.) as the conductive particles were mixed, further subjected to kneading treatment using a three roll mill, and defoamed under reduced pressure to manufacture a conductive paste (e).

### Example 6

100 parts by mass of the silicone composition obtained in Preparation Example 1, and 50 parts by mass of conductive aluminum oxide having an average particle diameter of 0.4 μm (Product name: EC-700, available from Titan Kogyo, Ltd.) as the conductive particles were mixed, further subjected to kneading treatment using a three roll mill, and defoamed under reduced pressure to manufacture a conductive paste (f).

### Example 7

100 parts by mass of the silicone composition obtained in Preparation Example 1, and 50 parts by mass of conductive fine particles having an average particle diameter of 3.0 μm, in which gold plating has been done onto the resin fine particles (Product name: Micropearl AU-203, available from Sekisui Chemical Co., Ltd.) as the conductive particles were mixed, further subjected to kneading treatment using a three roll mill, and defoamed under reduced pressure to manufacture a conductive paste (g).

### Example 8

100 parts by mass of the silicone composition obtained in Preparation Example 1, 1,000 parts by mass of silver powder having an average particle diameter of 6.9 μm (Product name: SILVEST TCG-7, available from Tokuriki Chemical Research Co., Ltd.) as the conductive particles, and 100 parts by mass of xylene as a solvent were mixed, further subjected to kneading treatment using a three roll mill, and defoamed under reduced pressure to manufacture a conductive paste (h).

### Comparative Example 1 to 3

### Comparative Example 1

100 parts by mass of the silicone composition obtained in Preparation Example 4, and 30 parts by mass of silver powder having an average particle diameter of 6.9 μm (Product name: SILVEST TCG-7, available from Tokuriki Chemical Research Co., Ltd.) as the conductive particles were mixed, further subjected to kneading treatment using a three roll mill, and defoamed under reduced pressure to manufacture a conductive paste (i). The conductive paste (i) was not sufficiently cured in the heat-curing process of the die bonding material, so that the subsequent process of wire bonding could not be performed, whereby a photosemiconductor package could not be obtained.

### Comparative Example 2

100 parts by mass of the epoxy composition obtained in Preparation Example 5, and 30 parts by mass of silver powder having an average particle diameter of 6.9 μm (Product name: SILVEST TCG-7, available from Tokuriki Chemical Research Co., Ltd.) as the conductive particles were mixed, further subjected to kneading treatment using a three roll mill, and defoamed under reduced pressure to manufacture a conductive paste (j).

### Comparative Example 3

100 parts by mass of the silicone composition obtained in Preparation Example 1, and 1,100 parts by mass of silver powder having an average particle diameter of 6.9 μm (Product name: SILVEST TCG-7, available from Tokuriki Chemical Research Co., Ltd.) as the conductive particles were mixed, and 100 parts by mass of xylene was mixed as a solvent, further subjected to kneading treatment using a three roll mill, and defoamed under reduced pressure to manufacture a conductive paste (k). The conductive paste (k) could not obtain sufficient workability in a stamping process of the die bonder (specifically transfer with a predetermined amount could not be done), and photosemiconductor devices could not be mounted, whereby a photosemiconductor package could not be obtained.

With regard to the compositions of Examples and Comparative Examples, the following various characteristics were measured. The results are shown in Table 2 and Table 3.

### [Preparation of Photosemiconductor Package]

As the package substrate for LED, a package substrate for LED having a concave portion for mounting a photosemiconductor device, and a silver plated first lead and a second lead being provided at the bottom thereof [SMD5050 (available from I-CHIUN PRECISION INDUSTRY CO., resin portion: PPA (polyphthalamide))], and as the photosemiconductor device, a vertical LED (EV-B35A manufactured by SemiLEDs Corporation) having a main light-emitting peak of 450 nm were prepared, respectively.

By using a die bonder (AD-830 manufactured by ASM Corp.), the respective conductive die bonding materials shown in Examples and Comparative Examples were each transferred to the silver plated first lead of the package substrate by stamping with a predetermined amount, and photosemiconductor devices were mounted thereon. Next, the package substrate was charged in an oven to cure the respective die bonding materials by heating (Examples 1 to 8, Comparative Example 1 and Comparative Example 3 were 150° C. for 1 hour, Comparative Example 2 was 170° C. for 4 hours), and the bottom electrode of the photosemiconductor device and the first lead were electrically connected. Then, by using a wire bonder, the package substrate for LED on which the photosemiconductor device has been mounted was electrically connected to the upper electrode of the photosemiconductor device and to the second lead by using a gold wire (available from Tanaka Denshi Kogyo K.K., FA: 25 μm), whereby each one sheet of the package substrate for LED (120 in the number of the packages) on which the photosemiconductor device has been mounted was obtained.

Then, a half of the sheet of the package substrate for LED (60 in the number of the packages) on which the photosemiconductor device has been mounted obtained above was collected, a silicone sealing material (Product name: KER2500, available from Shin-Etsu Chemical Co., Ltd.) was coated with a predetermined amount by using a dispensing apparatus (Super Σ CM II manufactured by Musashi Engineering, Inc.), and the sealing material was cured at 150° C. for 4 hours under heating.

Photosemiconductor packages with different conductive die bonding materials were prepared as mentioned above, and used for the following tests. Incidentally, those which can be manufactured without any problem in the process were judged as good, and those which were unable to manufacture due to any inconvenience caused were judged as poor and they are shown in Table 2 and Table 3.

### [Temperature Cycle Test]

Among the photosemiconductor packages to which the sealing material has been filled obtained by the above-mentioned method, 10 packages thereof were used for the temperature cycle test (−40° C. to 125° C., each 20 minutes by 1,000 cycles), presence or absence of the cracks at the conductive adhesive material portion of the sample after the test was observed by a microscope, and a number of the test pieces at which cracks have been generated/total test pieces were counted. Further, energization test of the sample after the test was carried out, and a number of the lit test pieces/total test pieces were counted.

### [High Temperature Lighting Test]

Among the photosemiconductor packages to which the sealing material has been filled obtained by the above-mentioned method, 10 packages thereof were used and lit under high temperature (85° C.) and energization of 350 mA for 1,000 hours, and then, the presence or absence of adhesion failure such as peeling between the photosemiconductor device and the bottom portion at the concave portion on which the photosemiconductor device has been mounted, etc., the presence or absence of generation of crack, and the presence or absence of discoloration of the adhesive layer around the photosemiconductor device were observed by a microscope, and a number of the test pieces at which appearance abnormality has been generated/total test pieces were counted. Further, energization test of the sample after the test was carried out, and a number of the lit test pieces/total test pieces were counted.

### [Die Shear Test]

Among the photosemiconductor packages to which the sealing material has not been filled obtained by the above-mentioned method, die shear strength of 10 packages thereof were measured in a room at 25° C. using a bond tester (Series 4000 manufactured by Dage Corp.), and an average value of the obtained measured values is shown by MPa.

Further, among the photosemiconductor packages to which the sealing material has not been filled obtained by the above-mentioned method, die shear strength of 10 packages thereof were measured after lighting for 1,000 hours under high temperature (85° C.) and energization of 350 mA, by using a bond tester (Series 4000 manufactured by Dage Corp.) similarly, and an average value of the obtained measured values is shown by MPa.

The obtained results are shown in Table 2 and Table 3.

TABLE 2

| | | Example | | | | | | | |
|---|---|---|---|---|---|---|---|---|---|
| | | 1 | 2 | 3 | 4 | 5 | 6 | 7 | 8 |
| Formulation | | 1 | 2 | 3 | 1 | 1 | 1 | 1 | 1 |
| Example | | | | | | | | | |
| Conductive resin | | a | b | c | d | e | f | g | h |
| composition | | | | | | | | | |
| Conductive | Kind of | Ag | Ag | Ag | TiO₂ | SiO₂ | Al₂O₃ | Gold | Ag |
| particles | particles | | | | | | | plated | |
| | | | | | | | | fine | |
| | | | | | | | | particles | |
| | Average | 6.9 | 6.9 | 6.9 | 0.3 | 0.3 | 0.4 | 3.0 | 6.9 |
| | particle | | | | | | | | |
| | diameter | | | | | | | | |
| | Formulated | 30 | 30 | 30 | 50 | 100 | 50 | 50 | 1,000 |
| | part(s) | | | | | | | | |
| Package formation | | good | good | good | good | good | good | good | good |
| possible or not | | | | | | | | | |
| Temperature | Number of | 0 | 0 | 0 | 0 | 0 | 0 | 0 | 0 |
| cycle | cracks | | | | | | | | |
| test | generated | | | | | | | | |
| (among 10 | Number of | 10 | 10 | 10 | 10 | 10 | 10 | 10 | 10 |
| samples | lighting | | | | | | | | |
| tested) | | | | | | | | | |
| High | Number of | 0 | 0 | 0 | 0 | 0 | 0 | 0 | 0 |
| temperature | abnormality | | | | | | | | |
| energization | in | | | | | | | | |
| test | appearance | | | | | | | | |
| (among 10 | generated | | | | | | | | |
| samples | Number of | 10 | 10 | 10 | 10 | 10 | 10 | 10 | 10 |
| tested) | lighting | | | | | | | | |
| Die | Before | 16.3 | 15.4 | 15.7 | 16.2 | 17.4 | 16.4 | 16.3 | 12.2 |
| shear | energization | | | | | | | | |
| MPa | test | | | | | | | | |
| | After | 16.1 | 15.4 | 15.8 | 16.2 | 17.1 | 16.8 | 15.9 | 12.3 |
| | energization | | | | | | | | |
| | test | | | | | | | | |
| Remarks | | | | Fumed | | | | | Solvent |
| | | | | silica | | | | | xylene |

TABLE 3

| | | Comparative Example | | |
|---|---|---|---|---|
| | | 1 | 2 | 3 |
| Formulation Example | | 4 | 5 | 1 |
| Resin composition | | i | j | k |
| Conductive | Kind of | Ag | Ag | Ag |
| particles | particles | | | |
| | Average | 6.9 | 6.9 | 6.9 |
| | particle | | | |
| | diameter | | | |
| | Formulation | 30 | 30 | 1,100 |
| | amount | | | |
| Package formation | | poor | good | poor |
| possible or not | | | | |
| Temperature | Number of | — | 2 | — |
| cycle test | cracks | | | |
| (among 10 | generated | | | |
| samples | Number of | — | 9 | — |
| tested) | lighting | | | |
| High | Number of | — | 10 | — |
| temperature | abnormality | | | |
| energization | in appearance | | | |
| test (among | generated | | | |
| 10 samples | Number of | — | 5 | — |
| tested) | lighting | | | |
| Die shear | Before | — | 29.1 | — |
| MPa | energization | | | |
| | test | | | |
| | After | — | 4.3 | — |
| | energization | | | |
| | test | | | |
| Remarks | | | | Solvent |
| | | | | xylene |

As shown in Table 2, in Example 1 to Example 8 in which the conductive resin compositions (a) to (h) which satisfy the range of the present invention are used as the die bonding material, crack was not generated after the temperature cycle test, and lighting was possible in all the packages. Also, in the high temperature energization test (high temperature lighting test), there was no change in appearance of the conductive resin composition, and lighting was possible in all the packages. Further, as a result of measurement of die shear before and after the high temperature energization test, it was found that photosemiconductor devices having high reliability with no change in adhesive force can be manufactured.

On the other hand, as shown in Table 3, in Comparative Example 1 in which Component (A) and Component (B) are silicone resin compositions which do not satisfy the range of the present invention, sufficient curing could not been done in the heat-curing process of the die bonding material and a good cured product could not be obtained. Therefore, the post process of wire bond could not be carried out, and a photosemiconductor package could not be manufactured.

In Comparative Example 2 in which Component (A) and Component (B) are epoxy resin compositions which do not satisfy the range of the present invention, crack and non-lighting of the cured product of the die bonding material were confirmed after the temperature cycle test. Also, after the high temperature energization test, the epoxy resin which had been changed to black by light and heat from the photosemiconductor device was confirmed, and further non-lighting was confirmed. Moreover, as a result of measurement of die shear before and after the high temperature energization test, lowering in adhesive force after the energization test was confirmed as compared to the initial stage of mounting the device.

In Comparative Example 3 in which Component (A) and Component (B) are silicone resin composition which satisfy the range of the present invention but the formulation amount of the conductive particles of Component (C) is out of the range of the same, sufficient workability could not be obtained in the stamping process by a die bonder (specifically a fixed amount transfer could not be done), and accordingly, the photosemiconductor devices could not be mounted stably, whereby the photosemiconductor package could not be obtained.

It must be stated here that the present invention is not restricted to the embodiments shown by the above-mentioned embodiments. The above-mentioned embodiments are merely examples so that any embodiments composed of substantially the same technical concept as disclosed in the claims of the present invention and expressing a similar effect are included in the technical scope of the present invention.

1. A thermosetting conductive silicone composition which comprises
(A) an organopolysiloxane having at least one structure represented by the following general formula (1) in the molecule: 100 parts by mass, 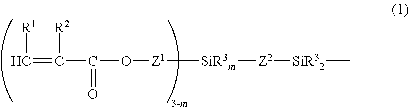
wherein “m” represents either of 0, 1 or 2; R¹ represents a hydrogen atom, a phenyl group or a halogenated phenyl group; R² represents a hydrogen atom or a methyl group; R³s may be the same or different from each other and each represents a substituted or unsubstituted monovalent organic group having 1 to 12 carbon atoms; Z¹ represents either of —R⁴—, —R⁴—O— or —R⁴(CH₃)₂Si—O— where R⁴s may be the same or different from each other and each represents a substituted or unsubstituted divalent organic group having 1 to 10 carbon atoms; and Z²s represent an oxygen atom or a substituted or unsubstituted divalent organic group having 1 to 10 carbon atoms which may be the same or different from each other;
(B) an organic peroxide: 0.1 to 10 parts by mass based on the total, amount of Component (A) as 100 parts by mass; and
(C) conductive particles: 0.1 to 1,000 parts by mass based on the solid contents of Component (A) and Component (B) as 100 parts by mass.

2. The thermosetting conductive silicone composition according to claim 1, wherein Z¹ in the organopolysiloxane of Component (A) is —R⁴—, and Z² of the same is an oxygen atom.

3. The thermosetting conductive silicone composition according to claim 1, wherein Z¹ in the organopolysiloxane of Component (A) is —R⁴—O— or —R⁴(CH₃)₂Si—O—, and Z² of the same is a substituted or unsubstituted divalent organic group having 1 to 10 carbon atoms which may be the same or different from each other.

4. The thermosetting conductive silicone composition according to claim 1, wherein 0.1 mole % or more of an (SiO₂) unit is contained in the organopolysiloxane of Component (A).

5. The thermosetting conductive silicone composition according to claim 2, wherein 0.1 mole % or more of an (SiO₂) unit is contained in the organopolysiloxane of Component (A).

6. The thermosetting conductive silicone composition according to claim 3, wherein 0.1 mole % or more of an (SiO₂) unit is contained in the organopolysiloxane of Component (A).

7. The thermosetting conductive silicone composition according to claim 1, wherein the organopolysiloxane of Component (A) has at least one structure represented by the following general formula (2) in the molecule, 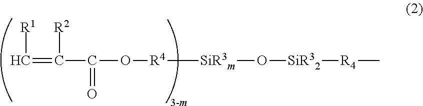
wherein “m”, R¹, R², R³ and R⁴ have the same meanings as defined above.

8. The thermosetting conductive silicone composition according to claim 2, wherein the organopolysiloxane of Component (A) has at least one structure represented by the following general formula (2) in the molecule, 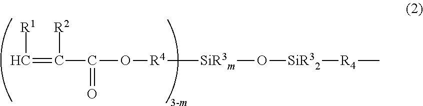
wherein “m”, R¹, R², R³ and R⁴ have the same meanings as defined above.

9. The thermosetting conductive silicone composition according to claim 3, wherein the organopolysiloxane of Component (A) has at least one structure represented by the following general formula (2) in the molecule, 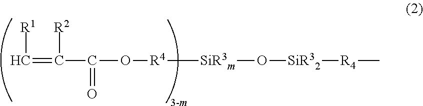
wherein “m”, R¹, R², R³ and R⁴ have the same meanings as defined above.

10. The thermosetting conductive silicone composition according to claim 4, wherein the organopolysiloxane of Component (A) has at least one structure represented by the following general formula (2) in the molecule, 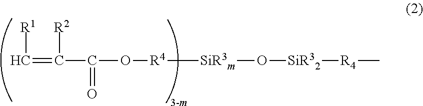
wherein “m”, R¹, R², R³ and R⁴ have the same meanings as defined above.

11. The thermosetting conductive silicone composition according to claim 5, wherein the organopolysiloxane of Component (A) has at least one structure represented by the following general formula (2) in the molecule, 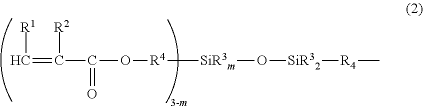
wherein “m”, R¹, R², R³ and R⁴ have the same meanings as defined above.

12. The thermosetting conductive silicone composition according to claim 6, wherein the organopolysiloxane of Component (A) has at least one structure represented by the following general formula (2) in the molecule, 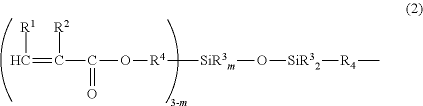
wherein “m”, R¹, R², R³ and R⁴ have the same meanings as defined above.

13. A conductive adhesive comprising the thermosetting conductive silicone composition according to claim 1.

14. A conductive die bonding material comprising the thermosetting conductive silicone composition according to claim 1, which is used to conductively connect a semiconductor device to a wiring board.

15. A photosemiconductor apparatus comprising a cured product obtained by curing the conductive die bonding material according to claim 14.
